(19) United States
(12) Patent Application Publication
(10) Pub. No.: US 2023/0219049 A1
(43) Pub. Date: Jul. 13, 2023

(54) MULTI-BED CATALYTIC REACTOR

(71) Applicant: CASALE SA, Lugano (CH)

(72) Inventors: Enrico Rizzi, Casnate con Bernate (IT); Matteo Masanti, Musso (IT)

(21) Appl. No.: 18/001,192

(22) PCT Filed: Jun. 22, 2021
(86) PCT No.: PCT/EP2021/066994

§ 371 Date: Dec. 8, 2022

(30) Foreign Application Priority Data
Jun. 25, 2020 (EP) 20182163.4

(51) Int. Cl. B01J 8/04; C01C 1/04

(52) U.S. Cl. CPC B01J 8/0415; B01J 8/0496; B01J 8/0492; C01C 1/0441; B01J 2208/00194

(57) ABSTRACT

A multi-bed catalytic reactor, particularly for the synthesis of ammonia, wherein the beds have an annular shape, the first bed has L(1)*(V/V(1)) equal to or greater than 50 wherein L(1) is the slenderness ratio of the first bed which is calculated as the axial length over the radial width; V is the total volume of the beds of the reactor and V(1) is the volume of the first bed.

### FIELD OF APPLICATION

The invention relates multi-bed catalytic reactors particularly for the synthesis of ammonia.

### PRIOR ART

Multi-bed catalytic reactors are chemical reactors containing a plurality of catalytic beds traversed sequentially by a process gas. In such reactors, by passing through the sequence of catalytic beds, a reactant gas is gradually converted into a product gas. Multi-bed reactors are typically used for the synthesis of ammonia starting from a makeup gas made essentially of hydrogen and nitrogen.

A common design of multi-bed reactors includes catalytic beds with a cylindrical annular configuration. Each catalytic bed is basically an annulus of a cylinder delimited by an outer wall and an inner wall. Said outer wall and inner wall are designed to be gas-permeable and suitable to retain the catalyst, which is e.g. in a granular form.

A heat exchanger may be installed in the central cavity of a catalytic bed to remove heat from the effluent. Such heat exchanger can be named inter-bed exchanger and is particularly useful when the chemical reaction is exothermic.

The heat removed from the hot effluent may be transferred to a cooling medium or to a process stream. The use of an inter-bed cooler, particularly after the first bed which is the most reactive, allows heat recovery and controls the inlet temperature of the subsequent bed.

An annular catalytic bed may be traversed with an inward flow directed towards the central axis or an outward flow directed away from the axis. A heat exchanger may be arranged in the central cavity of the annular bed in both cases. For example when the bed is traversed with an inward radial flow the gaseous flow enters the bed via the outer wall and is collected at the inner wall, from which it can directly enter the cavity and pass through the heat exchanger.

Typically the inter-bed heat exchanger is a tube heat exchanger; the hot gas may pass around the tubes or in the tubes (tube side) according to various embodiments.

The number of catalytic beds may vary. In most embodiments the number of catalytic beds is 2 to 4, which may be arranged vertically one above the other in a vertical apparatus.

This technique is well known but poses some challenges not yet overcome.

In the prior art the catalytic beds are always designed with the same inner and outer radius. It follows that the central cavities of the beds have a radial width which does not differ significantly from one bed to another and, consequently, the volume available for the catalyst is proportional to the axial length of the bed.

The process gas is most reactive at the inlet of the first bed and becomes gradually less reactive as it passes through the catalyst and the conversion of reagents into products takes place. For this reason the first bed, i.e. the bed that receives the fresh reactant gas, contains a relatively small portion of the total volume of catalyst. For example in a three-bed exchanger the first bed may account for about 20% of the volume of catalyst, the second bed for about 30% and the third bed for about 50%.

It follows that the first bed is the shortest in the axial direction and its central cavity provides only a limited room for hosting an inter-bed heat exchanger. On the other hand, the effluent of the first bed may be very hot due to the strong reaction of the fresh gas in contact with the catalyst.

The heat exchanger that can be installed in the small cavity of the first bed may not be able to cool the effluent gas to the desired inlet temperature of the second bed. In such a case the prior art teaches to cool the effluent of the first gas by quenching, i.e. mixing the hot gas with cool fresh gas directed to the inlet of the first bed. However this technique can be used to a limited extent taking into account the flow rate and temperature of the fresh gas and the optimum inlet temperature of the first bed. A too high temperature at the inlet of the first bed may cause overheating and must be avoided. The quenching may also reduce the performance of the reactor due to the dilution of the input fresh gas.

In attempt to compensate for the small volume available centrally in the first bed for the installation of the related inter-bed heat exchanger, the prior art has suggested to realize said heat exchanger with a large number of small tubes. This design may increase the heat exchange surface but deviates from the optimum as it makes the exchanger expensive and increases the pressure drop.

A prior art ammonia synthesis converter is described for example in EP 0 254 936 and CA 1 200 073.

### SUMMARY OF THE INVENTION

The invention aims to solve the above drawbacks and limitations of conventional multi-bed chemical reactors.

This aim is reached with a reactor according to the claims.

The idea underlying the invention is to provide the first catalytic bed with a slim design. This design allows more room for the installation of the central inter-bed heat exchanger and reduces the gas pressure drop significantly.

A reactor according to the invention is characterized in that the first catalytic bed satisfies the condition:

L(1)*(V/V(1)) equal to or greater than 50

wherein
L(1) is a slenderness ratio of the first bed which is calculated as B(1)/R(1);
R(1) is the radial width of the first bed;
B(1) is the length of the first bed measured along a central axis of radial symmetry of the bed;
V(1) is the volume of the first bed of the reactor, i.e. the bed that is positioned first in the sequence of catalytic beds from an input to an output of the reactor;
V is the total volume of the catalytic beds of the reactor.

The volume of a catalytic bed denotes the volume available for the catalyst.

The catalytic beds are numbered according to the order they are traversed by the process gas. The first bed is traversed first by the input gas; the second bed is traversed by the effluent of the first bed and so on. In some embodiments the effluent of a bed may be mixed with another stream (e.g. quenched) before it enters the next bed.

The radial width R of a catalytic bed can be determined as (Rext−Rint) where Rext is the distance of an outer peripheral surface of the bed from a central axis and Rint is the distance of an inner peripheral surface of the bed from said axis. For example said distances can be measured with reference to an outer wall and to an inner wall of the catalytic bed.

The above mentioned parameter L(1)*(V/V(1)) can be termed relative slenderness ratio of the first catalytic bed and denoted by the symbol LR(1), as it is in relation to the volume of the first bed compared to the total volume of the sequence of beds.

The same can be applied to other beds, so that L(i) and LR(i) may be used to denote the slenderness B(i)/R(i) and the relative slenderness of the i-th bed of the sequence.

The above defined relative slenderness is appropriate to describe the inventive design of the first catalytic bed because it takes into account the relative size of the first bed compared to other beds of the reactor, which corresponds to the fraction of catalyst that can be loaded in the first bed. Referring to this relative parameter is useful because for a given width the length of the bed, and consequently its absolute slenderness, is proportional to the volume. The design of the invention is best characterized by the relative slenderness as the first bed has a slim design even when its axial length is relatively small.

A first advantage of the invention is a larger room for accommodation of a heat exchanger in the central cavity of the first catalytic bed thanks to its slim design. Accordingly a larger heat exchange surface can be installed to recover the heat contained in the effluent of the first bed. The heat exchanger may be realized with a conventional design avoiding an expensive special design with tubes of a small diameter.

A second notable advantage is the reduction of the pressure drop of the gas flow across the first catalytic bed. Particularly the pressure drop of this bed is reduced due to: 1) a smaller radial thickness of the bed, and 2) a greater surface of the inner and outer collectors. The greater surface of the collectors results in a lower speed of the gas for a given flow rate traversing the bed, thus leading to a reduction of the pressure drops.

The reduced pressure drop is advantageous particularly in combination with the use of a fine catalyst. A fine catalyst is made of granules of small size, for example 1.5 mm or less. A fine catalyst is advantageous for the process but tends to have a greater pressure drop compared to a conventional catalyst. The invention compensates this drawback thus making more attractive the use of a fine catalyst.

In an interesting embodiment of the invention, the reactor includes an integrated heat recovery exchanger connected to a steam system. Said heat recovery exchanger may be for example a boiler or a steam superheater. In this embodiment a flow of steam or superheated steam can be produced internally in the reactor by recovering the heat at elevated temperature of the gas effluent from the first catalytic bed. Preferably said heat recovery exchanger is located in the upper part of a vertical reactor.

At least a portion of said heat recovery exchanger can be received in the central cavity of the first catalytic bed. The central cavity of the first catalytic bed may accommodate a portion of said heat recovery exchanger in addition to an inter-bed heat exchanger. The slim design of said bed facilitates this accommodation.

Accordingly, another advantage of the invention is the possibility to recover more heat at a high temperature from the hot effluent of the first bed. The heat recovered from said effluent can be used for production of steam, possibly superheated steam, directly in the reactor by means of an integrated recovery exchanger.

Still another advantage of the invention is a better exploitation of the internal volume of the reactor as will be detailed hereinbelow.

The invention may also be applied to the revamping of an existing reactor. For example a reactor may be revamped by replacing a catalytic cartridge with a new catalytic cartridge, wherein the new cartridge includes a first bed which satisfies the condition of L(1)*(V/V(1)) being equal to or greater than 50, according to the definitions given in claim 1.

### PREFERRED EMBODIMENTS

The relative slenderness LR(1) of the first bed is preferably greater than 55 and preferably greater than 60 or greater than 70.

Said parameter LR(1) may lie in a range of 50 to 1000 according to various embodiments. In case of an extra-slim design said parameter may be in the upper region of this range, for example 500 to 1000, preferably 600 to 700. In other cases said parameter LR(1) is most commonly in the lower half of the above disclosed range, particularly in the range 50 to 150, preferably 50 to 120. Even more preferably said parameter is in the range 60 to 110 or 70 to 100.

The absolute slenderness ratio L(1) of the first bed is preferably at least 10. For example L(1) is in the range 10 to 50. Preferred ranges are 10 to 30 or 10 to 20. Particularly preferably L(1) is in the range 10 to 15. For an extra-slim design a ratio in the range 25 to 50 may be adopted.

The first bed may have a radial width smaller than the radial width of any other bed in the reactor. The second and next beds may have the same radial width of converters of traditional design which is greater than the radial width of the first bed.

Preferably all the catalytic beds have a common outer diameter and the first bed has a radial width smaller than the radial with of the other beds. Consequently the first bed has a greater inner diameter leaving more space in the cavity for the accommodation of one or more heat exchangers. This embodiment is particularly preferred in a vertical reactor with the catalytic beds axially aligned one above the other.

In a preferred embodiment each bed of the sequence, from the first bed to the last bed, has a volume greater than that of the preceding bed of the sequence, i.e. V(i+1) is greater than V(i).

The volume of the first bed of the sequence, in a preferred embodiment, is not more than 15% of the total volume of the beds, i.e. the ratio V(i)/V is not greater than 0.15.

Preferably the catalytic beds are vertically arranged one above another according to their sequential order, so that for each pair of adjacent beds the underlying bed receives the effluent of the bed above, the first catalytic bed being on top of the reactor. A pair of adjacent beds denotes two beds traversed one after the other by the process gas, for example one pair is formed by the first bed and the second bed, another pair by the second bed and the third bed, and so on.

In a typical embodiment, particular for ammonia reactors, the number of catalytic beds is three.

In a vertical reactor with the first bed on top, a boiler or steam superheater can be placed above the inter-bed heat exchanger installed in the cavity of the first bed. Accordingly the boiler or steam superheater is on top of the reactor which facilitates the access for maintenance. A lower portion of said boiler or steam superheater may be received in the cavity of the first catalytic bed.

The incorporation of a steam superheater or of a boiler in the reactor has several advantages compared to an external apparatus. Particularly the piping, foundation, structure and related pressure drop and heat loss are avoided.

The catalytic beds of the reactor may contain the same or a different catalyst. Preferably all beds contain the same kind of catalyst.

In a preferred application of the invention the reactor is a reactor for the synthesis of ammonia. Accordingly the catalyst contained in the beds is a catalyst active to catalyse the synthesis of ammonia starting from a makeup gas containing hydrogen and nitrogen. The makeup gas can be produced conventionally in a front-end by reforming of a hydrocarbon such as natural gas or a synthesis gas.

As mentioned above one of the advantages of the invention is a better use of the internal volume of the reactor. It must be noted that the pressure vessel of the reactor is expensive, therefore the volume itself is expensive and its efficient use is a considerable advantage.

The better exploitation of the internal volume is an advantage particularly in the context of revamping an existing reactor. In such a case the existing pressure vessel, as a rule, cannot be replaced. Therefore a limited volume is available and its better use is a significant advantage.

Particularly in a vertical reactor the invention makes an efficient use of the upper region of the reactor in the zone between the top cover of the catalytic cartridge and the top cover of the pressure vessel of the reactor. In the prior art this volume is not used efficiently. In the invention it may be used also for the installation of a boiler or steam superheater, which is integrated in the reactor, and can be partially received within the first bed.

The advantages of the invention will emerge even more clearly with the aid of the detailed description below relating to a number of preferred embodiments.

### DESCRIPTION OF THE FIGURES

FIG. 1 shows a scheme of a reactor according to an embodiment.

FIG. 2 is a scheme of a catalytic bed of the reactor of FIG. 1.

FIG. 3 is an example of a functional scheme including a reactor according to a preferred application.

FIG. 4 shows a reactor according to another embodiment.

### DETAILED DESCRIPTION OF PREFERRED EMBODIMENTS

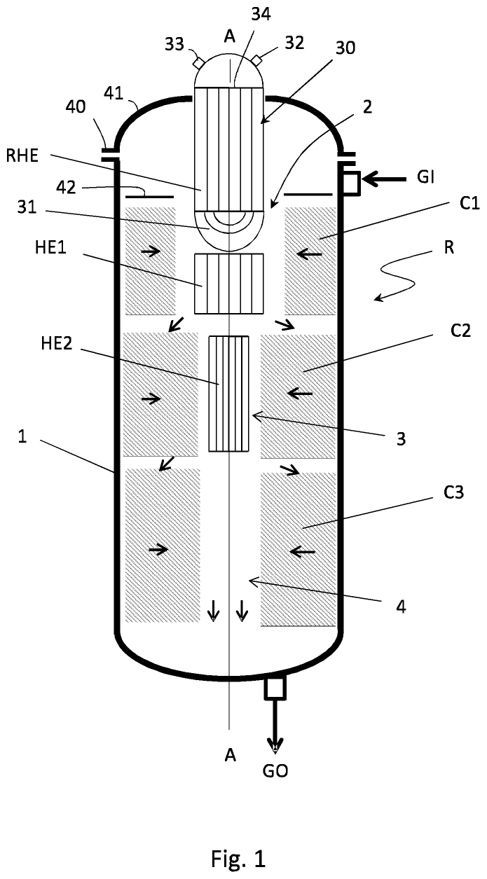

FIG. 1 illustrates the following items:
R Vertical reactor (e.g. ammonia converter)
A-A Axis of the reactor R
1 Pressure vessel of the reactor R
C1 First catalytic bed
C2 Second catalytic bed
C3 Third catalytic bed
2 Central cavity of the first catalytic bed C1
3 Central cavity of the second catalytic bed C2
4 Central cavity of the third catalytic bed C3
RHE Recovery heat exchanger on top of the reactor R
HE1 First inter-bed heat exchanger fitted in the central cavity 2 of the first bed C1
HE2 Second inter-bed heat exchanger fitted in the central cavity 3 of the second bed C2
GI Gas input of the reactor R (reactants)
GO Gas output of the reactor R (products)
30 bundle of u-tubes of the integrated recovery exchanger RHE
31 lower part of the u-bundle 30
32 inlet of the u-tubes
33 outlet of the u-tubes
34 tubesheet of the u-bundle 30
40 top flange of the pressure vessel 1
41 top cover of the pressure vessel 1
42 top cover of a catalytic cartridge containing the catalytic beds

The catalytic beds C1, C2 and C3 and the inter-bed heat exchangers HE1, HE2 may be part of a cartridge fitted in the pressure vessel 1. The cartridge may be removable from the pressure vessel.

The catalytic beds C1, C2 and C3 have a cylindrical annular shape. Each bed has a central cavity 2, 3 and 4 respectively.

The figure is schematic and the internals of the reactor are not illustrated in detail.

The reactor R is configured internally so that each catalytic bed is traversed by the reactant gas with a radial or axial radial flow. The flow is directed inwardly from the outer surface of the bed towards the axis A-A, as indicated by the arrows in FIG. 1.

The inlet gas GI is directed to the first catalytic bed C1 and may be preheated in one or more of the heat exchangers of the reactor, for example in the inter-bed exchangers HE1 and HE2. For example the gas may pass first in the exchanger HE2 and then in the hotter exchanger HE1. The input gas may also be passed in the annular space between the pressure vessel 1 and a catalytic cartridge in order to cool the pressure vessel 1. Before entry into the first catalytic bed C1 the preheated gas may be mixed with a portion of cold gas to carefully adjust the inlet temperature of the bed. The reactor may include an additional input for said cold gas.

FIG. 1 illustrates an embodiment wherein the reactor R optionally includes an integrated recovery heat exchanger RHE fitted in the upper part of the pressure vessel 1. Particularly said heat exchanger RHE is a tube heat exchanger arranged to heat water or steam entering at the inlet 32 and leaving at the outlet 33. Said inlet 32 and outlet 33 may be connected to a steam system of the ammonia plant.

The hot effluent of the first bed C1 passes in the region around the tubes of said integrated recovery heat exchanger RHE and around the tubes of the first inter-bed exchanger HE1. Each of said heat exchangers is basically a bundle of tubes internally traversed by a suitable medium. The hot effluent gas passes around the tubes and transfers heat to the medium inside the tubes.

Particularly preferably, the top exchanger RHE is a steam superheater or a boiler and the medium inside its tubes is hot steam which is superheated with the heat transferred from the hot gas or boiler feed water that is evaporated.

FIG. 1 shows an exemplary embodiment where the integrated exchanger RHE is a u-tubes apparatus. The lower part of said heat exchanger, particularly the lower portion 31 of its tube bundle 30, is received within the cavity 2.

The medium inside the tubes of the inter-bed exchanger HE1 may be the fresh gas which is preheated before entering the first bed.

As seen in FIG. 1, the first bed C1 has a slim design thanks to a reduced radial width, compared to the subsequent beds C2 and C3.

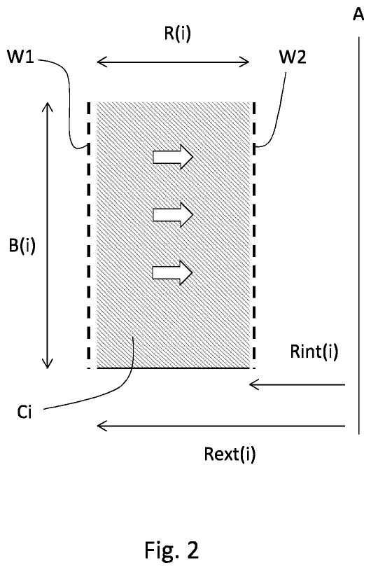

This feature can be better understood looking at FIG. 2. A generic bed Ci (e.g. any of C1 to C3 of FIG. 1) can be described geometrically with reference to a radial width R(i), an axial length B(i) in the direction of the axis A-A. The width R(i) can be regarded as the difference between an outer radius Rext(i) and an inner radius Rint(i) of the catalytic bed.

In a preferred embodiment the second bed and subsequent beds have the same radial width while the first bed has a reduced width which gives it a slim design. For example in a three-bed converter R(2)=R(3)>R(1). Preferably the beds have the same outer radius Rext; the first bed has a greater inner radius Rint. In a three beds embodiment therefore Rint(1) is greater than Rint(2) and Rint(3).

FIG. 2 also illustrates the gas-permeable walls W1 and W2 which contain the catalyst. Said walls act as gas distributor and collectors. In case of inward radial flow for example the outer wall W1 is an inlet gas distributor and the inner wall W2 is an outlet gas collector. Said walls may be realized with perforations or slots so that they are permeable to the gas but at the same time they are able to retain the catalyst.

Looking again at FIG. 1, it can be seen that the width R(1) of the first bed C1 is smaller than widths R(2) and (R3) of the second bed and third bed. This is in contrast with the conventional design of the prior art wherein all beds have the same width R.

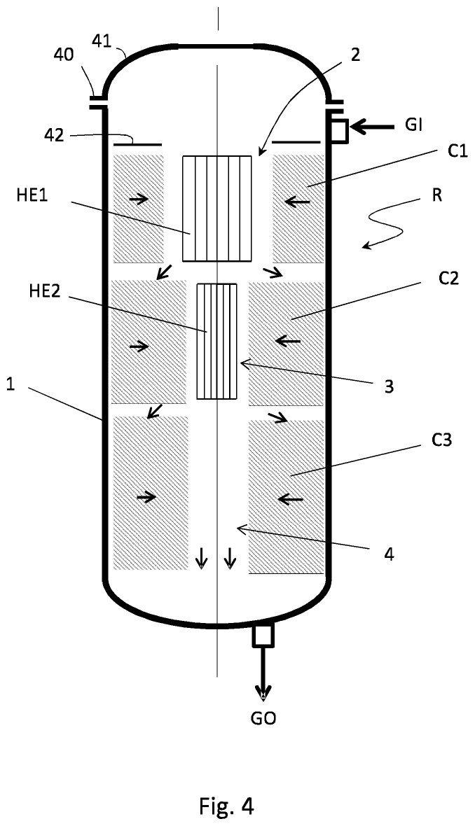

For a given volume of the first bed C1, for example 15% of the total volume of beds, the first bed C1 has therefore a smaller width R and a greater length B compared to the conventional design. This increases the size (diameter and length) of the central cavity 2 allowing for installation of a larger heat exchange surface for the recovery of heat from the effluent. In the example, this increased size of the cavity 2 can be exploited to facilitate the installation of the integrated recovery exchanger RHE in addition to the inter-bed exchanger HE1. In other embodiments the enlarged cavity 2 is exploited for the installation of a single inter-bed heat exchanger, which is larger than the inter-bed exchanger that can be installed with a conventional design of the bed. For example FIG. 4 illustrates an embodiment wherein the reactor does not include the integrated exchanger RHE and the cavity 2 is used for the installation of the inter-bed exchanger only.

The recovery exchanger RHE, if provided, is preferably above the inter-bed exchanger HE1. Due to the vertical design of the reactor R, this means the exchanger RHE is on the top of the reactor. This facilitates access to the exchanger RHE and its removal from the reactor.

After a passage around the tubes of the exchangers RHE and HE1, the effluent gas is redirected to the second bed C2 which is also traversed inwardly. Then the effluent of the second bed passes through the second inter-bed heat exchanger HE2 installed in the cavity 3 of the second bed C2. Said exchanger HE2 may also be a tube apparatus and the medium inside the tubes may be incoming gas GI to be preheated. For example the incoming gas may be initially preheated in the heat exchanger HE2 and then further preheated in the exchanger HE1.

After a passage through the second inter-bed heat exchanger HE2 the process gas is directed to the third bed C3 which is also traversed with inward radial flow. The effluent of the third bed C3 is collected in the space 4 and represent the fully reacted outlet gas GO. A heat exchanger may optionally be installed also in the space 4.

The arrows in FIG. 1 indicate schematically the gas flow. Suitable internals of the reactor provide the necessary distribution and collection of the gas.

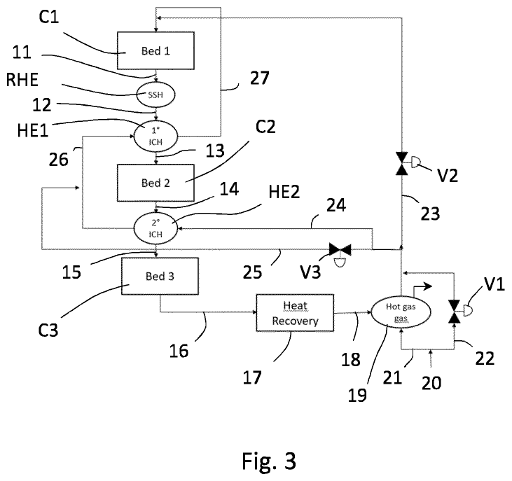

FIG. 3 illustrates a process scheme that can be implemented with a multi-bed reactor according to the invention. Particularly the scheme of FIG. 3 may be implemented when the reactor is an ammonia converter.

The numerals in FIG. 3 denote the following.
11 partially reacted process gas effluent from the first bed C1 directed to the integrated exchanger (e.g. steam superheater) RHE
12 process gas after passage through the exchanger RHE directed to the first inter-bed exchanger HE1
13 process gas after passage through the first inter-bed heat exchanger HE1 directed to the inlet of the second bed C2
14 process gas effluent from the second bed C2
15 process gas after passage through the second inter-bed heat exchanger HE2, at the inlet of the third bed C3
16 fully reacted process gas (product stream) effluent from the third bed C3
17 external heat recovery heat exchanger
18 product gas effluent of the heat exchanger 17
19 gas-gas heat exchanger
20 fresh process gas (reactants)
21 portion of gas 20 directed to the gas-gas heat exchanger 19
22 portion of gas 20 bypassing the gas-gas heat exchanger 19, controlled by valve V1.
23 cold fresh gas directed to the inlet of the first bed, controlled by valve V2
24 fresh gas directed to the second inter-bed heat exchanger HE2
25 fresh gas bypassing the second inter-bed heat exchanger HE2, controlled by valve V3
26 pre-heated fresh gas directed to the first inter-bed heat exchanger HE1
27 fully pre-heated fresh gas effluent from the exchanger HE1 and directed to the inlet of the first bed together with the cold gas 23.

As can be seen in FIG. 3, the temperature of the process gas at the inlet of the beds is controlled via the valves V1, V2 and V3.

Particularly, the valve V2 controls the flow rate of the “cold shot” 23, i.e. a stream of fresh gas which is not preheated in the inter-bed exchangers HE2 and HE1. This cold gas 23 is mixed at the inlet of the first bed C1 with the fully preheated stream 27 effluent from the first inter-bed exchanger HE1. The mixture of the stream 23 and stream 27 forms the inlet gas of the first catalytic bed.

The partially reacted gas 11 from the first bed C1 is at elevated temperature (e.g. above 500° C.) and transfers heat to a superheating steam in the exchanger RHE. The so obtained superheated steam may be used in the process as a heat source or to produce energy.

The effluent 12, still at a high temperature, transfer heat in the first inter-bed exchanger HE1 to the reactant stream 26. Said stream 26 is the result of mixing the stream 24 preheated in the second inter-bed exchanger HE2 with the bypass stream 25. Therefore the temperature of the stream 13 is controlled basically by the valve V3 which controls the bypass line of stream 25.

Also, the temperature of the cold gas in lines 23 and 25 is controlled by the valve V1, as it is the result of mixing the effluent of the exchanger 19 with the gas 22 bypassing the same.

The product stream 16 leaving the third bed C3 may be cooled in the recovery exchanger 17. This exchanger 17 and also the gas-gas exchanger 19 may be installed in the annular cavity 4 of the third bed (i.e. inside the pressure vessel) or may be external.

It can be appreciated that the valves V1, V2 and V3 operates on streams of cold gas. No valve is required on hot lines such as lines 26 or 27. This is a considerable advantage because a valve operating on a hot stream at high pressure would be a critical and expensive item.

It can also be appreciated that the invention provides an efficient recovery of the heat generated by the chemical reaction, particularly of the heat contained in the hot process streams 11, 14 and 15.

The gas 18 after cooling in the exchanger 19 represents the product gas.

In the preferred embodiment of ammonia converter, the fresh gas 20 is ammonia makeup gas containing hydrogen and nitrogen and the product gas 18 is an ammonia-containing product gas.

FIG. 4 illustrates another embodiment wherein only the first inter-bed heat exchanger HE1 is installed in the cavity 2 of the first catalytic bed C1. Other particulars correspond to those of FIG. 1.

1-14. (canceled)

15. A reactor, comprising:
a plurality of catalytic beds for converting a reactant gaseous flow into a gaseous product flow wherein:
wherein the plurality of catalytic beds have a cylindrical annular shape delimited by an outer cylindrical wall and an inner cylindrical wall;
wherein the plurality of catalytic beds are arranged inside a pressure vessel sequentially from a first bed to a last bed according to a path of the gaseous flow from an inlet to an outlet of the reactor, so that for each pair of consecutive beds an effluent gas of an upstream bed of the pair is further processed in the downstream bed of the pair;
wherein the plurality of catalytic beds have collectively a volume V and each i-th bed of the sequence has a volume V(i);
wherein each bed in a i-th position in the sequence has a radial width R(i) and an axial length B(i), the length B being measured along a central axis of radial symmetry of the annular bed;
wherein said first bed satisfies the condition:
L(1)*(V/V(1)) equal to or greater than 50
wherein:
L(1) is a slenderness ratio of the first bed which is calculated as B(1)/(R(1); and
V(1) is a volume of the first bed.

16. The reactor according to claim 15, wherein the first bed satisfies the condition:
L(1)*(V/V(1)) is greater than 55.

17. The reactor according to claim 16 wherein L(1)*(V/V(1)) is greater than 60.

18. The reactor according to claim 16 wherein L(1)*(V/V(1)) is greater than 70.

19. The reactor according to claim 15, wherein the first bed satisfies the condition:
L(1)*(V/V(1)) is in a range 50 to 1000.

20. The reactor according to claim 15, wherein the slenderness ratio L(1) of the first bed is at least 10.

21. The reactor according to claim 20 wherein said slenderness ratio L(1) of the first bed is in a range 10 to 50.

22. The reactor according to claim 15 wherein all the plurality of catalytic beds have a common outer diameter and the first bed has a radial width smaller than the radial with of the other beds.

23. The reactor according to claim 15, wherein each bed of the sequence, from the first bed to the last one, has a volume greater than that of the preceding bed of the sequence.

24. The reactor according to claim 15, wherein the volume of the first bed of the sequence is not more than 15% of the total volume of the plurality of catalytic beds.

25. The reactor according to claim 15 wherein the plurality of catalytic beds are vertically arranged one above another according to their sequential order, so that for each pair of adjacent beds the underlying bed receives the effluent of the bed above, the first catalytic bed being on top of the reactor.

26. The reactor according to claim 15 wherein the number of catalytic beds is three.

27. The reactor according to claim 15 wherein all of the plurality of catalytic beds contains the same kind of catalyst.

28. The reactor according to claim 15, further comprising at least one heat exchanger located in a central cavity of the first bed and arranged to remove heat from the effluent of the first bed.

29. The reactor according to claim 15 wherein the reactor is a reactor for synthesis of ammonia, a catalyst contained in the plurality of catalytic beds is active to catalyse the synthesis of ammonia starting from a makeup gas containing hydrogen and nitrogen.

30. A process of synthesis of ammonia, wherein a makeup gas containing hydrogen and nitrogen is generated in a front-end by reforming a hydrocarbon source and said makeup gas is reacted to form ammonia in the reactor according to claim 29.
